(19) United States
(12) Patent Application Publication
(10) Pub. No.: US 2020/0376731 A1
(43) Pub. Date: Dec. 3, 2020

(54) Plastic Injection Mechanism of Plastic Injection Apparatus

(71) Applicant: BAN CHIH WANG, Taichung (TW)

(72) Inventor: BAN CHIH WANG, Taichung (TW)

(21) Appl. No.: 16/607,338

(22) PCT Filed: Dec. 4, 2017
(86) PCT No.: PCT/CN2017/114391

§ 371 Date: Oct. 22, 2019

(51) Int. Cl. B29C 45/53; B29C 45/54; B29C 45/62; B29C 45/60

(52) U.S. Cl. CPC B29C 45/531; B29C 45/60; B29C 45/62; B29C 45/54

(57) ABSTRACT

A plastic injection mechanism (20) of a plastic injection apparatus used for extruding molten plastic into a mold (16) comprises a fixing base (22); a material injection device (28) pivotably attached to the fixing base (22); and a rotating device (30) disposed between the material injection device (28) and the fixing base (22), the rotating device (30) being connected to the material injection device (28), wherein driving the rotating device (30) causes the material injection device (28) to move in a linked manner, enabling the material injection device (28) to rotate and shift with respect to the fixing base (22). The material injection device (28) of the plastic injection mechanism (20) can be adjusted to be in an inclined state, enabling a user to carry out excess material discharge and cleaning conveniently.

### BACKGROUND OF THE INVENTION

### 1. Technical Field

The present invention relates to injection molding, and more particularly to a plastic injection mechanism for injecting molten plastic into a mold.

### 2. Description of Related Art

Typically, injection molding is a manufacturing process for producing plastic products by injecting molten plastic into a mold. After the mold is cooled, the plastic products are taken out from the mold.

A plastic injection mechanism is used to inject molten plastic. The conventional plastic injection mechanism needs to be cleaned to remove residual plastic after a predetermined time of use or when the plastic injection mechanism is used to inject another material.

When the conventional plastic injection mechanism is cleaned, the plastic injection mechanism has to be removed from the machine. However, the conventional plastic injection mechanism is very heavy, so that the removing work is not easy and sometimes it is very dangerous.

### BRIEF SUMMARY OF THE INVENTION

In view of the above, the primary objective of the present invention is to provide a plastic injection mechanism of a plastic injection apparatus, which may quickly remove residual plastic, and clean in an easy way.

In order to achieve the objectives of the present invention, a plastic injection mechanism of a plastic injection apparatus comprises a fixing base; a material injection device pivoted on the fixing base; and a rotating device provided between the material injection device and the fixing base to swing the material injection device with respect to the fixing base.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of the plastic injection apparatus of a preferred embodiment of the present invention;

FIG. 2 is a perspective view of the plastic injection mechanism of the preferred embodiment of the present invention;

FIG. 3 is an exploded view of the plastic injection mechanism of the preferred embodiment of the present invention;

FIG. 4 is a front view of preferred embodiment of the present invention, showing the plastic injection mechanism being leaned; and

FIG. 5 is an exploded view of the material injection device of the preferred embodiment of the present invention.

### DETAILED DESCRIPTION OF THE INVENTION

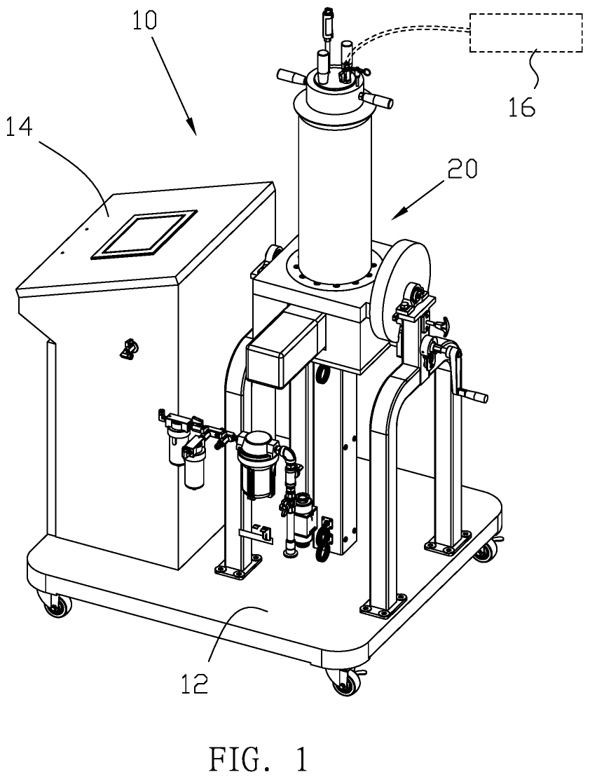

As shown in FIG. 1, a plastic injection apparatus of the preferred embodiment of the present invention includes a base 12, on which a controller 14 and a plastic injection mechanism 20 are provided. The controller 14 is connected to the plastic injection mechanism 20 to control a plastic injecting process of the plastic injection mechanism 20, so that the plastic injection mechanism 20 injects molten plastic into a mold 16.

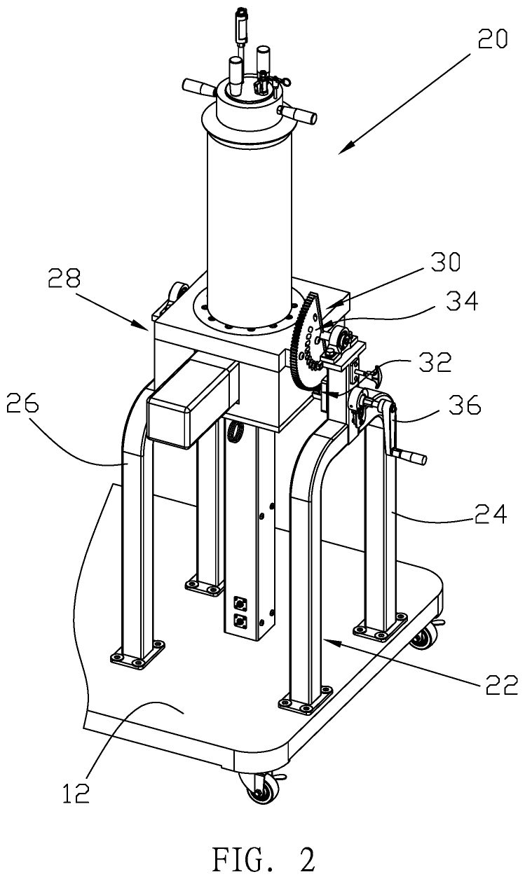

As shown in FIG. 2, the plastic injection mechanism 20 includes a fixing base 22, which includes a first frame 24 and a second frame 26. The first and the second frames 24, 26 are substantially reversed U-shaped members. Ends of the first and the second frames 24, 26 are fixed to the base 12 and kept a predetermined distance from each other.

The plastic injection mechanism 20 includes a material injection device 28, in which the molten plastic is received and ready to be injected. The material injection device 28 is pivoted on the fixing base 22 between the first and the second frames 24, 26. As a result, the material injection device 28 is controllable to change a direction of a nozzle thereof.

The plastic injection mechanism 20 includes a rotating device 30 between the material injection device 28 and the first frame 24 of the fixing base 22. The rotating device 30 is connected to the material injection device 28.

As the description above, driving the rotating device 30 is able to swing the material injection device 28 with respect to the fixing base 22.

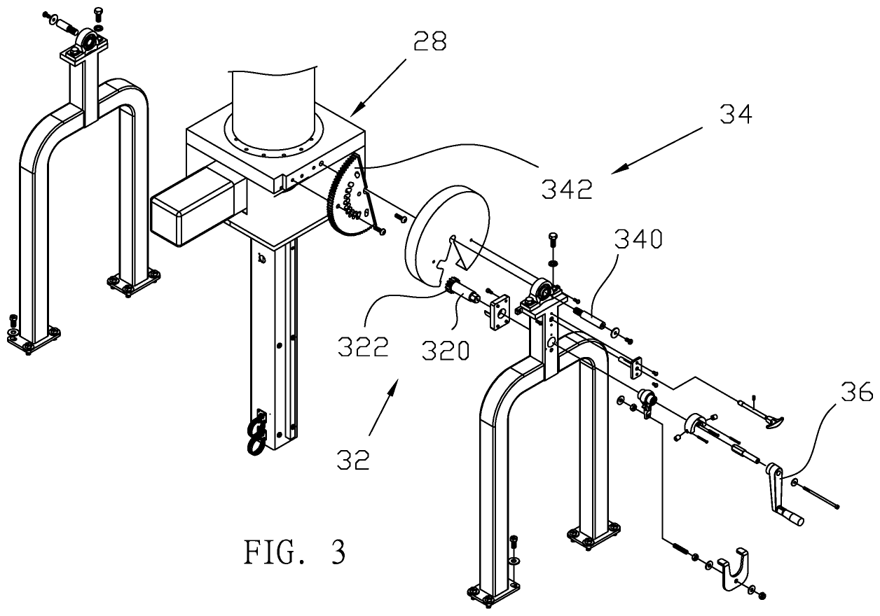

As shown in FIGS. 2 and 3, the rotating device 30 includes a driving gear 32, a driven gear 34, and a driving handle 36. The driven gear 34 is fixed to an outer surface of the material injection device 28, the driving gear 32 is meshed with the driven gear 34, and the driving handle 36 is connected to the driven gear 34.

As shown in FIG. 3, the driving gear 32 has a driving shaft 320 and a driving gear member 322 on an end of the driving shaft 320. The driven gear 34 has a driven shaft 340 and a driven gear member 342. An end of the driven shaft 340 passes through the driven gear member 342, and then is fixed to the outer surface of the material injection device 28 while the other end of the driven shaft 340 is pivoted on the first frame 24 of the fixing base 22. The driving gear member 322 passes through the first frame 24 of the fixing base 22 to be meshed with the driven gear member 342. The driving shaft 320 is pivoted on the first frame 24 of the fixing base 22 and connected to the driving handle 36.

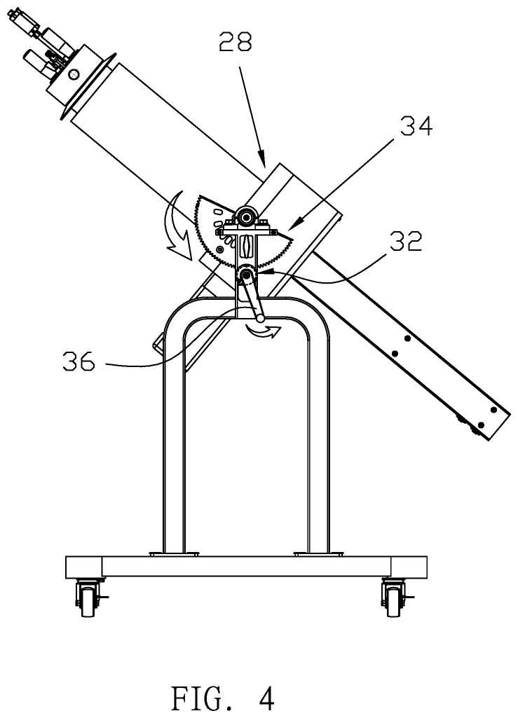

In combination with the elements as described above, as shown in FIG. 4, operating the driving handle 36 may driving the material injection device 28 to rotate through the driving gear 32 and the driven gear 34.

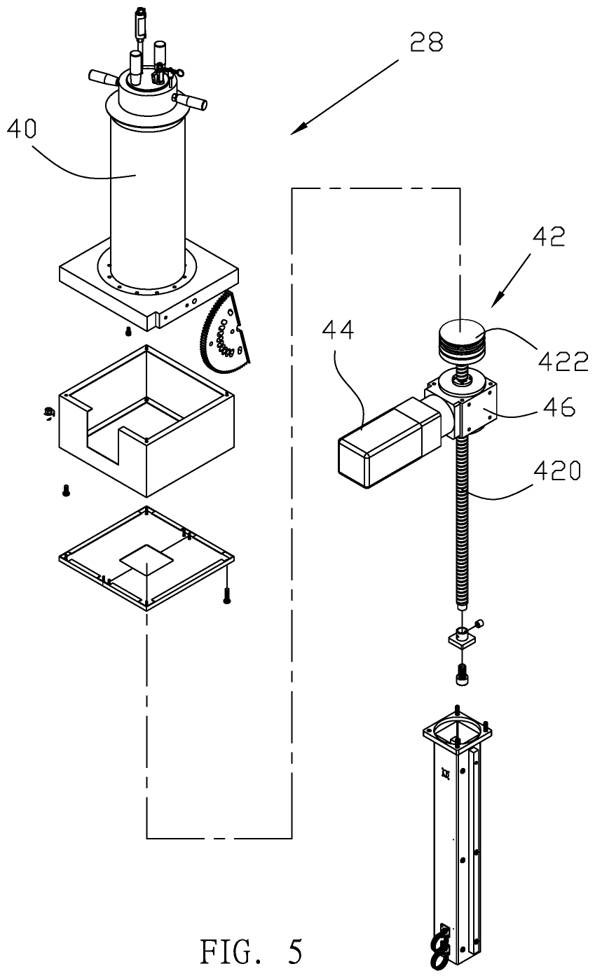

As shown in FIG. 5, the material injection device 28 includes a barrel 40, a piston assembly 42, a motor 44 and a gearbox 46. The piston assembly is movably received in the barrel 40, including a screw bar 420 and a piston member 422 on an end of the screw bar 420. The screw bar 420 is connected to the gearbox 46, and the gearbox 46 is connected to the motor 44. The piston member 422 is received in the barrel 40. The motor 44 drives the screw bar 420 through the gearbox 46 to move the piston member 422 so as to inject the molten plastic in the barrel 40.

The material injection device 28 is swung by the rotating device 30 to lean in a predetermined direction for user to clean the material injection device 28 and to remove the residual plastic in the barrel 40.

It must be pointed out that the embodiments described above are only some preferred embodiments of the present invention. All equivalent structures which employ the concepts disclosed in this specification and the appended claims should fall within the scope of the present invention.

What is claimed is:

1. A plastic injection mechanism of a plastic injection apparatus for extruding molten plastic into a mold, comprising:
a fixing base;
a material injection device pivoted on the fixing base; and
a rotating device provided between the material injection device and the fixing base to swing the material injection device with respect to the fixing base.

2. The plastic injection mechanism of the plastic injection apparatus of claim 1, wherein the rotating device includes a driving gear, a driven gear, and a driving handle; the driven gear is fixed to an outer surface of the material injection device; the driving gear is meshed with the driven gear; the driving handle is connected to the driven gear to be operated to swing the material injection device.

3. The plastic injection mechanism of the plastic injection apparatus of claim 2, wherein the driving gear has a driving shaft and a driving gear member on an end of the driving shaft; the driven gear has a driven shaft and a driven gear member; an end of the driven shaft passes through the driven gear member and is fixed to an outer surface of the material injection device while the other end of the driven shaft is pivoted on the fixing base; the driving gear member is meshed with the driven gear member; the driving gear member passes through the fixing base to be meshed with the driven gear member.

4. The plastic injection mechanism of the plastic injection apparatus of claim 1, wherein the fixing base includes a first frame and a second frame; the first and the second frames are fixed to the base and kept a predetermined distance from each other; the material injection device is provided between the first frame and the second frame while the rotating device is provided between the material injection device and the first frame.

5. The plastic injection mechanism of the plastic injection apparatus of claim 1, wherein the material injection device includes a barrel, a piston assembly, a motor, and a gearbox; the piston assembly is movably received in the barrel; the piston member is connected to the gearbox, and the gearbox is connected to the motor.

6. The plastic injection mechanism of the plastic injection apparatus of claim 5, wherein the piston member includes a screw bar and a piston member on an end of the screw bar; the screw bar is connected to the gearbox, and the gearbox is connected to the motor.
